(19) United States
(12) Patent Application Publication
(10) Pub. No.: US 2015/0229396 A1
(43) Pub. Date: Aug. 13, 2015

(54) APPARATUS AND METHOD FOR PROCESSING SIGNAL OF BASESTATION

(71) Applicant: ELECTRONICS AND TELECOMMUNICATIONS RESEARCH INSTITUTE, Daejeon (KR)

(72) Inventors: Hoon LEE, Daejeon (KR); Hyeong Sook PARK, Daejeon (KR); Kyung Yeol SOHN, Daejeon (KR); Youn Ok PARK, Daejeon (KR)

(73) Assignee: ELECTRONICS AND TELECOMMUNICATIONS RESEARCH INSTITUTE, Daejeon (KR)

(21) Appl. No.: 14/615,454

(22) Filed: Feb. 6, 2015

(30) Foreign Application Priority Data
Feb. 12, 2014 (KR) 10-2014-0016137

(51) Int. Cl. H04B 10/2575; H04W 72/04

(52) U.S. Cl. CPC H04B 10/25752; H04W 72/0453; H04W 88/08

(57) ABSTRACT

The present invention relates to a signal processing apparatus and method of a basestation. The apparatus according to the present invention includes a plurality of first processing units which allocates transmission data to a predetermined frequency band and transmits a transmission signal in which control information is allocated to a guard band in the predetermined frequency band; a plurality of second processing units which extracts the control information from the guard band in the predetermined frequency band for a reception signal to perform a corresponding operation and extracts the transmission data from the predetermined frequency band to transmit the transmission data through the antenna; and an optical transmitting unit which combines a plurality of transmission signals received from the plurality of first processing units into one signal to transmit the signal to the plurality of second processing units through the optical cable.

### CROSS-REFERENCE TO RELATED APPLICATIONS

This application claims priority to and the benefit of Korean Patent Application No. 10-2014-0016137 filed in the Korean Intellectual Property Office on Feb. 12, 2014, the entire contents of which are incorporated herein by reference.

### TECHNICAL FIELD

The present invention relates to an apparatus and a method for processing a signal of a basestation and more particularly, to a technology which allocates transmission signal and control information to an band of a signal which is transmitted between a digital unit (DU) and a RF unit (RU) of a basestation based on a radio over fiber (RoF).

### BACKGROUND ART

Recently, in order to reduce an installation cost of a basestation and ensure easiness of management thereof in a wireless transmission system, there are lots of tries to physically separate a digital unit (DU) and a RF unit (RU) and connect the DU and the RU through a cable to transmit a signal. In this case, the RoF based basestation has a structure which connects the DU and the RU through an optical cable and transmits a signal from the DU to the RU or from the RU to the DU through the optical cable.

As a technology of a cloud basestation is actively being developed, demands for connecting as many as possible RUs to a cloud basestation which is connected to optical cable have increased in recent years. Therefore, a technology which allocates a plurality of IF bands to one optical wavelength and allocates a plurality of transmission data to the IF bands is being developed.

During this process, the DU requires a separate control channel which controls the RU and collects status information. To this end, a control channel is allocated to a band which is separate from the IF band which transmits the transmission data and control information is transmitted through the control channel.

However, when the separate band is allocated in order to allocate the control channel, resource is consumed. Further, the as the number of DUs and RUs which are connected to optical is increased, restrictions on the bandwidth which is assigned to the DU and the RU at one optical wavelength may occur.

### SUMMARY OF THE INVENTION

The present invention has been made in an effort to provide a signal processing apparatus and method of a basestation which may transmit transmission data and RF control information in an IF band (or RF band if the digital unit (DU) and RF unit (RU) transmit signal using RF band) without allocating a separate band for transmitting the RF control information when the transmission data and the RF control information are allocated to an IF band (or RF band if the DU and RU are transmit signal using RF band) of a signal which is transmitted between a DU and a RU of a basestation based on a radio over fiber (RoF).

The present invention has been made in an effort to further provide a signal processing apparatus and method of a basestation which may easily utilize a resource even when transmission data and RF control information are transmitted to a plurality of IF bands (or a RF band if the DU and RU transmit signal using RF band) which is allocated to one optical signal.

An exemplary embodiment of the present invention provides a signal processing apparatus of a basestation including a a plurality of first processing units which allocates transmission data to a predetermined frequency band and transmits a transmission signal in which control information is allocated to a guard band in the predetermined frequency band through an optical cable; a plurality of second processing units which extracts the control information from the guard band in the predetermined frequency band for a reception signal which is received through the optical cable to perform a corresponding operation and extracts the transmission data from the predetermined frequency band to transmit the transmission data through the antenna; and an optical transmitting unit which combines a plurality of transmission signals received from the plurality of first processing units into one signal to transmit the signal to the plurality of second processing units through the optical cable.

The plurality of first processing units may include a data allocating unit which splits the predetermined frequency band of the transmission signal into a plurality of sub channels to allocate the transmission data and allocates the control information to the sub channel corresponding to the guard band in the frequency band; a modulating unit which IF modulates the transmission signal; a filter unit which filters a signal of the predetermined frequency band from the IF modulated signal; and a transmitting unit which transmits the signal of the predetermined frequency band to the optical transmitting unit.

Different frequency bands may be allocated to the plurality of first processing units.

The plurality of second processing units may include a first filter unit which filters an IF band signal in the reception signal; a modulating unit which RF modulates the IF band signal; a second filter unit which filters a signal of the predetermined frequency band in the RF modulated signal; a data extracting unit which extracts the transmission data which is allocated to the sub channels of the predetermined frequency band and extracts the control information which is allocated to the sub channel corresponding to the guard band in the predetermined frequency band; and an output nit which outputs the transmission data and the control information which are extracted by the data extracting unit.

The optical transmitting unit may include a combiner which combines a plurality of transmission signals; an electrical/optical converter which converts one electrical signal combined by the combiner into an optical signal to output the converted signal to the optical cable; an optical/electrical converting unit which receives the optical signal which is output to the optical cable to convert the optical signal into an electrical signal; and a distributor which splits electrical signal which is converted by the optical/electrical converting unit into a plurality of signals to transmit the split signals to the plurality of second processing units.

The plurality of second processing units may correspond to the plurality of first processing units, individually.

The plurality of second processing units may be set to detect a signal of the same frequency band as the first processing unit corresponding to the second processing units.

The plurality of first processing units may be the plurality of digital units (DUs) and the plurality of second processing units may be the plurality of radio units (RUs). On the other hand, the plurality of first processing units may be the plurality of RUs and the plurality of second processing units are the plurality of DUs.

Another exemplary embodiment of the present invention provides a signal processing method of a basestation, including: allocating transmission data to a predetermined frequency band and transmitting a transmission signal in which control information is allocated to a guard band in the predetermined frequency band by a plurality of first processing units; combining a plurality of transmission signals which is received from the plurality of first processing units into one signal to output the signal to the optical cable, by the optical transmitting unit; splitting a reception signal which is received from the optical cable into a plurality of signals to transmit the signals to a plurality of second processing units, by the optical transmitting unit; and extracting the control information from the guard band in the predetermined frequency band for a reception signal to perform a corresponding operation and extracting the transmission data from the predetermined frequency band to transmit the transmission data through the antenna, by the plurality of second processing units.

The signal processing method of the basestation may further include IF modulating the transmission signal in the plurality of first processing units; and filtering a signal of the predetermined frequency band in the IF modulated signal.

The signal processing method of the basestation may further include filtering an IF band signal from the reception signal in the plurality of second processing units; RF modulating the IF band signal; and filtering a signal of the predetermined frequency band in the RF modulated signal.

The signal processing method of the basestation may further include, before the transmitting of the transmission signal, allocating different frequency bands to the plurality of DU.

The signal processing method of the basestation may further include, before the transmitting of the transmission signal, setting to detect a signal of the same frequency band as the corresponding first processing unit by the plurality of second processing units.

According to the exemplary embodiments of the present invention, it is possible to easily utilize a resource even when transmission data and RF control information are transmitted to a plurality of IF bands which is allocated to one optical signal, by allocating the transmission data and the RF control information in the IF band without allocating a separate band for transmitting the RF control information when the transmission data and the RF control information are allocated to an IF band of a signal which is transmitted between a DU and a RU of a basestation based on a radio over fiber (RoF).

### BRIEF DESCRIPTION OF THE DRAWINGS

FIG. 1 is a diagram illustrating a configuration of a signal processing apparatus of a basestation according to an exemplary embodiment of the present invention.

FIG. 2 is a block diagram illustrating a configuration of a DU according to an exemplary embodiment of the present invention.

FIG. 3 is a block diagram illustrating a configuration of a RU according to an exemplary embodiment of the present invention.

FIG. 4 is an exemplary diagram illustrating a detailed configuration of a signal processing apparatus of a basestation according to an exemplary embodiment of the present invention.

FIG. 5 is an exemplary diagram illustrating a transmitted signal structure of a DU according to an exemplary embodiment of the present invention.

FIG. 6 is an exemplary diagram illustrating an IF signal structure which is applied to a signal processing apparatus of a basestation according to an exemplary embodiment of the present invention.

FIG. 7 is a flowchart illustrating an operation flow of a signal transmitting method of a DU according to an exemplary embodiment of the present invention.

FIG. 8 is a flowchart illustrating an operation flow of a signal transmitting method of a RU according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to accompanying drawings. In this case, like components are denoted by like reference numerals in the drawings as much as possible. Further, a detailed description of a function and/or a configuration which has been already known will be omitted. In the following description, parts which are required to understand an operation according to various exemplary embodiments will be mainly described and a description on components which may cloud a gist of the description will be omitted.

Some components of the drawings will be exaggerated, omitted, or schematically illustrated. However, a size of the component does not completely reflect an actual size and thus the description is not limited by a relative size or interval of the components illustrated in the drawings.

The present invention relates to a signal processing apparatus and method of a basestation. The signal processing apparatus of a basestation may include a first processing unit, a second processing unit and a optical transmitting unit. However, in the following exemplary embodiment, a description will be provided on the assumption that the first processing unit is a digital unit and the second processing unit is a radio frequency (RF) unit, but is not limited thereto.

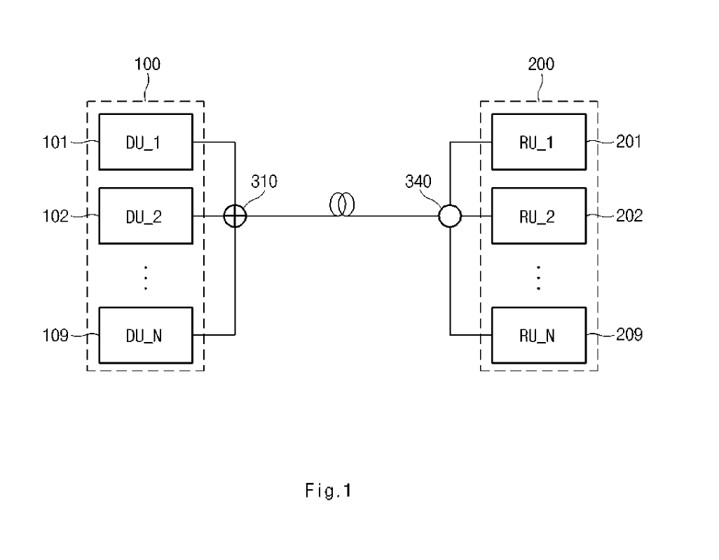

FIG. 1 is a diagram illustrating a configuration of a signal processing apparatus of a basestation according to an exemplary embodiment of the present invention.

A signal processing apparatus of a basestation according to an exemplary embodiment of the present invention is an apparatus which is applied to a cloud basestation and as illustrated in FIG. 1, may have a configuration in which a digital unit (DU) 100 and a RF unit (RU) 200 are physically separated.

Here, the signal processing apparatus of the basestation transmits a signal based on the radio over fiber (RoF) and the DU 100 and the RU 200 may be connected by an optical cable.

The DU 100 and the RU 200 each may be provided plural and a plurality of DUs 101, 102, . . . , 109 and a plurality of RUs 201, 202, . . . , 209 may be also connected by one optical cable.

As described above, when signals which are generated from the plurality of DUs 101, 102, . . . , 109 are transmitted through one optical cable, the signal processing apparatus of the basestation secures a plurality of intermediate frequency (IF) bands to transmit signals of the DUs 101, 102, . . . , 109 for one optical signal which is transmitted through the optical cable and allocates the plurality of IF bands to the DUs 101, 102, . . . , 109. But the present invention is not limited to the IF band. Plurality of radio frequency (RF) bands can be allocated to the DUs 101, 102, . . . , 109 if the DU and RU transmit signal using RF band. However, the following exemplary embodiments will be described mainly on the IF band.

For example, an f1 band may be allocated to the a first DU 101, an f2 band may be allocated to the a second DU 102, and an IF band of f_{N} band may be allocated to an N-th DU 109. In this case, it is assumed that f1, f2, . . . , f_{N} are different frequency bands.

Therefore, the plurality of DUs 101, 102, . . . , 109 loads transmission data and control information in the allocated IF bands to be transmitted, respectively. Here, the DUs 101, 102, . . . , 109 allocate the control information to guard bands of the IF bands which are allocated to the corresponding DUs 101, 102, . . . , 109 in advance to transmit the control information without using a separate band to allocate the control information.

In this case, the plurality of DUs 101, 102, . . . , 109 each is connected to a combiner 310 and the combiner 310 may combine the signals output from the plurality of DUs 101, 102, . . . , 109 to transmit the combined signal to the optical cable. Further, the plurality of RUs 201, 202, . . . , 209 each is connected to a distributor 340 to receive the signal which is received by the optical cable from the distributor 340.

Here, the plurality of RUs 201, 202, . . . , 209 may be provided so as to correspond to the plurality of DUs 101, 102, . . . , 109, respectively. However, in some exemplary embodiments, at least two DUs may correspond to one RU. However, in the exemplary embodiment of the present invention, it is assumed that the plurality of DUs 101, 102, . . . , 109 corresponds to the plurality of RUs 201, 202, . . . , 209, respectively. In this case, the plurality of RUs 201, 202, . . . , 209 may be set to detect a signal of the same frequency band as the corresponding DUs 101, 102, . . . , 109.

For example, a first RU 201 corresponds to a first DU 101 to process a signal which is transmitted from the first DU 101 and a second RU 202 corresponds to a second DU 102 to process a signal which is transmitted from the second DU 102. Further, an N-th RU 209 corresponds to an N-th DU 109 to process a signal which is transmitted from the N-th DU 109.

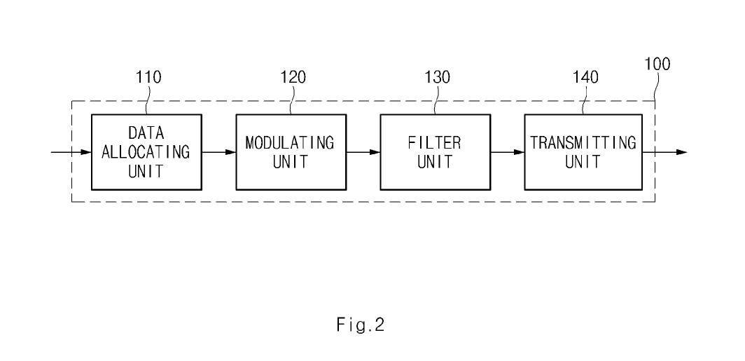

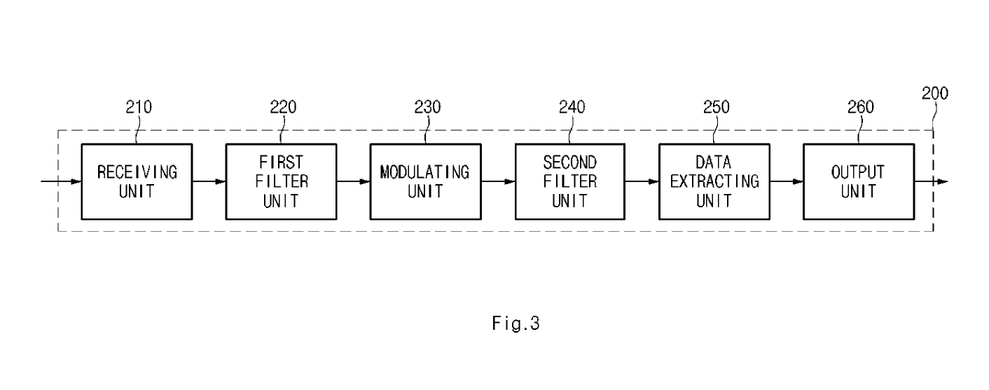

Therefore, detailed configurations of the DUs 101, 102, . . . , 109 and the RUs 201, 202, . . . , 209 will be described in more detail with reference to FIGS. 2 and 3.

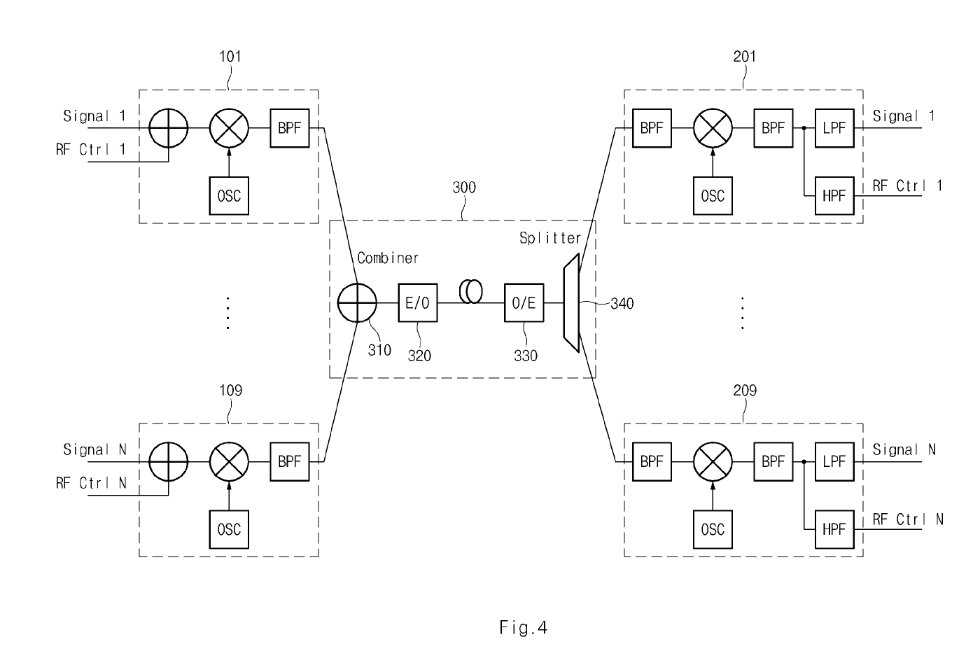

In the meantime, even though not illustrated in FIG. 1, a signal which is output by the combiner 310 is converted into an optical signal by an electric/optical converter to be transmitted through the optical cable and a signal which is transmitted through the optical cable is converted into an electric signal by an optical/electric converter to be transmitted to the distributor 340. Detailed description thereof will be made by referring to an exemplary embodiment of FIG. 4.

FIG. 2 is a block diagram illustrating a detailed configuration of the DU according to an exemplary embodiment of the present invention.

Referring to FIG. 2, the DU 100 according to an exemplary embodiment of the present invention includes a data allocating unit 110, a modulating unit 120, a filter unit 130, and a transmitting unit 140.

First, the data allocating unit 110 allocates data and radio frequency (RF) control information to be transmitted from the DU 100 to an IF band which is allocated to the DU 100. In this case, the IF band which is assigned to the DU 100 includes a plurality of sub channels and the data allocating unit 110 may allocate the data to each of the sub channels.

In the meantime, a guard band is allocated to a boundary portion of the IF bands among the sub channels of the IF band in order to block an interference with other adjacent signal band. In this case, the guard band may be allocated in various ranges in accordance with a wireless method.

For example, in the case of WiMax-Adv., 20 MHz band is allocated as a guard band and in this case, entire bands are split into 2048 sub channels and 0-th to 159-th sub channels and 1889-th to 2047-th sub channels are allocated in the guard band. Further, in the case of LTE-Adv., 847 sub channels among 2048 sub channels are allocated in the guard band. This is merely an exemplary embodiment and it is understandable that the allocated area of the guard band may vary depending on the exemplary embodiments.

A relatively wide frequency band is allocated in order for the guard band to be operated even in a low band pass filter characteristic of the RF, which may vary depending on a performance of the filter.

Such a guard band is a section which is basically allocated to all signal bands at the time of transmitting an RF signal so that the present invention intends to transmit the RF control information using the guard band.

In other words, the data allocating unit 110 allocates data to be transmitted to an area other than the guard band in the IF band and allocates the RF control information to the guard band. In this case, the guard band is allocated to the boundary area at a front stage and a back stage of the IF band and the RF control information may be allocated to any one of the two guard bands. According to an exemplary embodiment, the RF control information is first allocated to a first guard band and when an amount of RF control information is large, the RF control information may be allocated to a second guard band.

The modulating unit 120 performs IF modulation from a transmission signal to a frequency signal using information to which data and RF control information are allocated by the data allocating unit 110. In this case, the modulating unit 120 performs an inverse fast Fourier transform (IFFT) on the transmission signal to transform the transmission signal into a time domain signal.

The filter unit 130 may include a band pass filter (BPF) and filter the IF band signal from a signal which is modulated by the modulating unit 120. In this case, the transmitting unit 140 transmits the IF signal which is filtered by the filter unit 130 to the combiner which is illustrated in FIG. 1.

FIG. 3 is a block diagram illustrating a configuration of the RU according to an exemplary embodiment of the present invention.

Referring to FIG. 3, a RU 200 according to an exemplary embodiment of the present invention includes a receiving unit 210, a first filter unit 220, a modulating unit 230, a second filter unit 240, a data extracting unit 250, and an output unit 260.

First, the receiving unit 210 receives a signal which is transmitted from the DU. In this case, the receiving unit 210 may be provided with the IF signal which is received through the optical cable in FIG. 1 from the distributor. In this case, the receiving unit 210 provides the received IF signal to the first filter unit 220.

The first filter unit 220 may include a band pass filter and filter an IF band signal which is allocated to the RU 200 among the IF signals which are received through the receiving unit 210 to provide the filtered signal to the modulating unit 230.

The modulating unit 230 modulates the signal in which the IF band is filtered by the first filter unit 220 into an RF band signal. In this case, the RF signal which is modulated by the modulating unit 230 is provided to the second filter unit 240.

The second filter unit 240 may include a band pass filter and filter an RF band signal of a signal which is RF modulated by the modulating unit 230. In this case, the RF band signal which is filtered by the second filter unit 240 is provided to the data extracting unit 250.

In the meantime, the data extracting unit 250 extracts transmission data and RF control information from an RF band signal which is provided from the second filter unit 240. Here, the data extracting unit 250 may include a first data extracting unit (not illustrated) which extracts transmission data from the RF band signal and a second data extracting unit (not illustrated) which extracts the RF control information. In this case, the first data extracting unit filters a frequency area to which data is allocated in the DU to extract the transmission data. In the meantime, the second data extracting unit filters the guard band to which the RF control information is allocated in the DU to extract the RF control information.

For example, when the RF control information is allocated to a guard band having a high frequency channel among the guard bands of the IF band, which is allocated to the DU, in the DU, the first data extracting unit may include a low pass filter (LPF) and the second data extracting unit may include a high pass filter (HPF) with respect to a frequency which splits a data region and a guard band. Accordingly, the first data extracting unit may extract transmission data from the low pass filter and the second data extracting unit may extract RF control information from the high pass filter.

As another example, when the RF control information is allocated to a guard band having a low frequency channel among the guard bands of the IF band, which is allocated to the DU, in the DU, the first data extracting unit may include a high pass filter (HPF) and the second data extracting unit may include a low pass filter (LPF) with respect to a frequency which splits a data region and a guard band. Accordingly, the first data extracting unit may extract transmission data from the high pass filter and the second data extracting unit may extract RF control information from the low pass filter.

The transmission data and RF control information which are extracted from the RF band signal by the data extracting unit 250 are provided to the output unit 260. In this case, the output unit 260 may radiate the transmission data through an antenna. Further, the output unit 260 transmits the RF control information to a control unit of the RU 200 to control an operation of the RU 200 in accordance with the RF control information.

FIG. 4 is an exemplary diagram illustrating a detailed configuration of a signal processing apparatus of a basestation according to an exemplary embodiment of the present invention.

Referring to FIG. 4, each of the N DUs 101 to 109 may include a combiner, an oscillator, a multiplier, and a band pass filter.

For example, when a signal N including transmission data and an RF Ctrl N including RF control information are input to the N-th DU, a combiner of the N-th DU combines the signal N and the RF Ctrl N. In this case, the oscillator generates a signal including a frequency component of the IF band which is assigned to the N-th DU and the multiplier combines the signal N and the RF Ctrl N with the frequency component of the IF band which is generated by the oscillator. The multiplier allocates the RF Ctrl N in the guard band of the IF band.

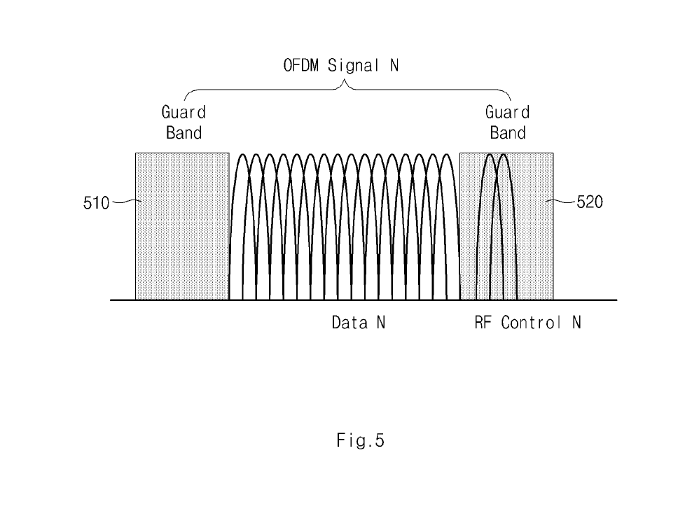

In the IF signal to which the signal N and the RF Ctrl N are allocated by the multiplier, the IF band which is assigned to the N-th DU by the band pass filter is filtered and a signal of the IF band which is filtered by the band pass filter is transmitted to an optical transmitting unit 300. In this case, the signal which is transmitted by the N-th DU may be illustrated in FIG. 5.

In other words, as illustrated in FIG. 5, the N-th DU may allocate the Data N to a sub channel of the IF band which is assigned to the N-th DU. In this case, the Data N may be allocated to a region other than the guard band of the IF band. In the meantime, boundary areas 510 and 520 are guard bands in the IF band which is assigned to the N-th DU. In this case, the N-th DU may allocate the RF Ctrl N to a sub channel of one of the guard bands of the IF band, for example, a region corresponding to a reference numeral 520.

As described above, N DUs each transmit a signal of the IF band to which the signal N and the RF Ctrl N are allocated to the optical transmitting unit 300.

In the meantime, the optical transmitting unit 300 may include a combiner 310 which combines signals of the IF bands which are received from the N DUs 101 to 109 as one IF signal and an electrical/optical (E/O) converting unit 320 which converts an electrical IF signal which is combined by the combiner 310 into an optical signal to transmit the converted signal to the N RUs 201 to 209 through the optical cable in order to transmit and receive a signal between the N DUs 101 to 109 and the N RUs 201 to 209 through the optical cable.

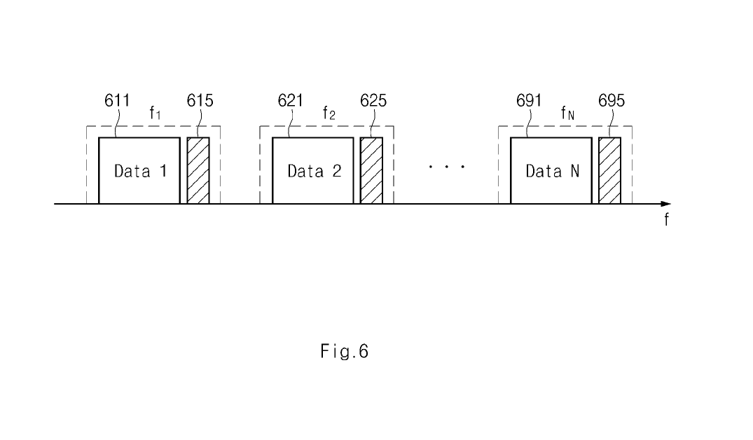

In this case, the IF signal which is obtained by combining the signals of the IF band received from the N DUs 101 to 109 by the combiner 310 of the optical transmitting unit 300 may be illustrated in FIG. 6.

In other words, as illustrated in FIG. 6, the IF signal which is combined by the combiner 310 includes IF bands of f1, f2, . . . , f_{N} and in this case, Data 1 611 and RF Ctrl 1 615 which are allocated to the f1 from the first DU 101 are combined in an f1 band and Data 2 621 and RF Ctrl 2 625 which are allocated to the f2 from the second DU are combined in an f2 band. In this manner, Data N 691 and RF Ctrl N 695 which are allocated from the N-th DU 109 are combined in an f_{N} band.

Accordingly, the IF signal which is combined by the combiner 310 includes Data 1 611, Data 2 612, . . . , Data N 691 and RF Ctrl 1 615, RF Ctrl 2 625, . . . , RF Ctrl N 695 corresponding to the data and the IF signal is transmitted to the N RUs 201 to 209 through the optical cable.

The optical transmitting unit 300 may include an optical/electrical (0/E) converting unit 330 which converts an optical signal which is received through the optical cable into the electrical IF signal and a distributor 340 which splits the IF signal converted by the optical electrical converting unit 330 into N lines to distribute the N lines to the N RUs 201 to 209. Here, the distributor 340 may be a splitter.

In the meantime, the N RUs 201 to 209 each may include a first band pass filter, an oscillator (OSC), a multiplier, a second band pass filter, and a filter which extracts transmission data and RF control information.

For example, when an IF signal is received from the distributor 340, the first band pass filter of the N-th RU 209 filters a signal of the IF band which is assigned to the N-th RU among the received IF signals. In this case, the oscillator generates a signal including a frequency component of the RF band corresponding to the IF band which is assigned to the N-th RU and the multiplier combines the signal of the IF band which is filtered by the first band pass filter and the signal which is generated by the oscillator to modulate the signal of the IF band into a signal of the RF band.

The second band pass filter filters the RF band in an RF modulated signal by the combiner and transmits the filtered RF band signal to the low pass filter and the high pass filter. In FIG. 4, it is assumed that the N DUs 101 to 109 allocate the RF control information to a high frequency guard band among the IF bands. Accordingly, the low pass filter of the N RU 209 filters a band excluding the guard band to which the RF control information is allocated and extracts the Signal N including the transmission data and outputs the Signal N. Further, the high pass filter of the N RU 209 filters the guard band to which the RF control information is allocated and extracts the RF Ctrl N including the RF control information and outputs the RF Ctrl N.

As described above, the signal processing apparatus of a basestation according to an exemplary embodiment of the present invention may transmit the transmission data and the RF control information together through the IF band which is assigned to transmit the transmission data without allocating a separate control channel between a plurality of DUs and a plurality of RUs.

Even though the above embodiments described for a case that a signal is transmitted from the DUs to the RUs, it can be applied to other case that a signal is transmitted from the RUs to the DUs, by the procedure in the opposite direction of the case. An operation flow of the signal processing apparatus of a basestation according to the exemplary embodiment of the present invention configured as described above will be described below in more detail.

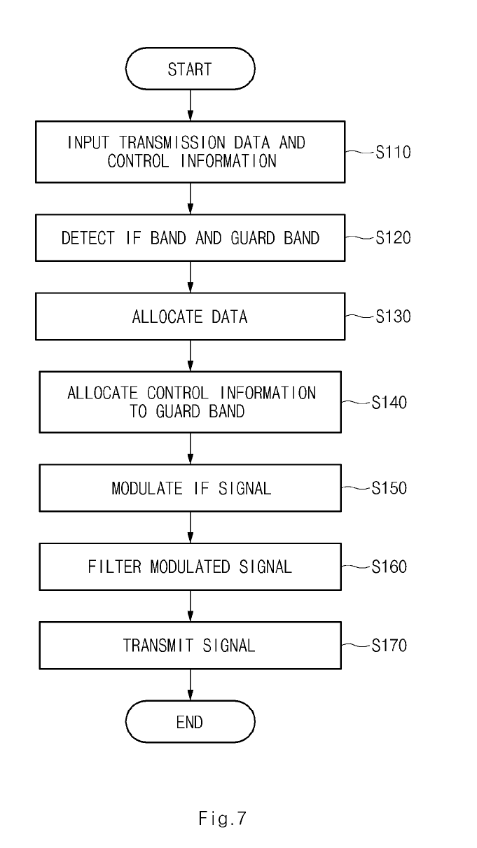

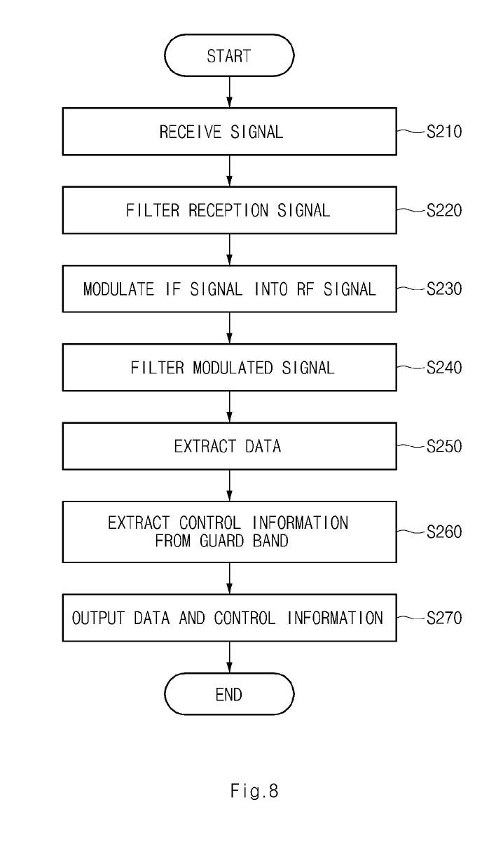

FIGS. 7 and 8 are flowcharts illustrating an operation flow of a signal transmitting method of a basestation according to an exemplary embodiment of the present invention.

First, FIG. 7 illustrates an operation flow of a DU and when transmission data to be transmitted through a RU and RF control information of the RU are input in step S110, a DU detects information on an IF band which is assigned to the DU and a guard band in the IF band in step S120.

In this case, the DU allocates the transmission data which is input in step “S110” based on the information of the IF band which is detected in step “S120” in step S130 and allocates the RF control information based on the information of the guard band in the IF band which is detected in step “S120” in step S140.

Next, the DU modulates a signal to which the transmission data and the RF control information are allocated in steps “S130” and “S140” into an IF signal in step S150 and filters a signal of the IF band which is assigned to the DU from the IF signal which is modulated in step “S150” in step S160, and loads the signal in an RoF link which is formed between the DU and the RU to transmit the signal in step S170.

If a plurality of DUs is provided, a process of receiving signals of the IF bands from the DUs to combine the signals may be further performed.

In the meantime, FIG. 8 illustrates an operation flow of the RU and when the IF signal is received from the RoF link in step S210, the RU primarily filters a signal of the IF band which is assigned to the RU in step S220.

Next, the RU modulates a signal of the IF band which is filtered in step “S220” into a signal of the corresponding RF band in step S230 and secondarily filters the signal of the RF band from the RF signal which is modulated in step “S230” in step S240.

In this case, the RU extracts transmission data from a region in which the transmission data is allocated among signals of the RF band which is secondarily filtered in step “S240” in step S250, and extracts the RF control information from the guard band in the RF band in step S260 to output the transmission data and the RF control information extracted in steps “S250” and “S260” in step S270.

In step “S270”, the RU may output the transmission data through the antenna and the RF control information may be output by the control unit of the RU.

When the various exemplary embodiments described above are executed by one or more computers or processors, the present invention may be implemented as a code which is readable by a processor in a processor readable recording medium. The processor readable recording medium includes all types of recording devices in which data readable by a processor is stored. Examples of a processor readable recording medium include a ROM, a RAM, a CD-ROM, a magnetic tape, a floppy disk, and an optical data storing device and also include a medium which is implemented as a carrier wave such as the transmission through the Internet. Further, the processor readable recording medium is distributed in computer systems connected through a network and the processor readable code is stored therein and executed in a distributed manner.

The specified matters and limited exemplary embodiments and drawings such as specific elements in the present invention have been disclosed for broader understanding of the present invention, but the present invention is not limited to the exemplary embodiments, and various modifications and changes are possible by those skilled in the art without departing from an essential characteristic of the present invention. Therefore, the spirit of the present invention is defined by the appended claims rather than by the description preceding them, and all changes and modifications that fall within metes and bounds of the claims, or equivalents of such metes and bounds are therefore intended to be embraced by the range of the spirit of the present invention.

What is claimed is:

1. A signal processing apparatus of a basestation, comprising:
a plurality of first processing units which allocates transmission data to a predetermined frequency band and transmits a transmission signal in which control information is allocated to a guard band in the predetermined frequency band through an optical cable;
a plurality of second processing units which extracts the control information from the guard band in the predetermined frequency band for a reception signal which is received through the optical cable to perform a corresponding operation and extracts the transmission data from the predetermined frequency band to transmit the transmission data through the antenna; and
an optical transmitting unit which combines a plurality of transmission signals received from the plurality of first processing units into one signal to transmit the signal to the plurality of second processing units through the optical cable.

2. The apparatus of claim 1, wherein the plurality of first processing units includes:
a data allocating unit which splits the predetermined frequency band of the transmission signal into a plurality of sub channels to allocate the transmission data and allocates the control information to the sub channel corresponding to the guard band in the frequency band;
a modulating unit which IF modulates the transmission signal;
a filter unit which filters a signal of the predetermined frequency band in the IF modulated signal; and
a transmitting unit which transmits the signal of the predetermined frequency band to the optical transmitting unit.

3. The apparatus of claim 1, wherein different frequency bands are allocated to the plurality of first processing units.

4. The apparatus of claim 1, wherein the plurality of second processing units includes:
a first filter unit which filters an IF band signal in the reception signal;
a modulating unit which RF modulates the IF band signal;
a second filter unit which filters a signal of the predetermined frequency band in the RF modulated signal;
a data extracting unit which extracts the transmission data which is allocated to the sub channels of the predetermined frequency band and extracts the control information which is allocated to the sub channel corresponding to the guard band in the predetermined frequency band; and
an output unit which outputs the transmission data and the control information which are extracted by the data extracting unit.

5. The apparatus of claim 1, wherein the optical transmitting unit includes:
a combiner which combines a plurality of transmission signals;
an electrical/optical converter which converts one electrical signal combined by the combiner into an optical signal to output the converted signal to the optical cable;
an optical/electrical converting unit which receives the optical signal which is output to the optical cable to convert the optical signal into an electrical signal; and
a distributor which splits the electrical signal which is converted by the optical/electrical converting unit into a plurality of signals to transmit the split signals to the plurality of second processing units.

6. The apparatus of claim 1, wherein the plurality of second processing units corresponds to the plurality of first processing units, individually.

7. The apparatus of claim 6, wherein the plurality of second processing units is set to detect a signal of the same frequency band as the corresponding first processing units corresponding to the second processing units.

8. The apparatus of claim 1, wherein the plurality of first processing units are the plurality of digital units (DUs) and the plurality of second processing units are the plurality of radio frequency units (RUs).

9. The apparatus of claim 1, wherein the plurality of first processing units are the plurality of RUs and the plurality of second processing units are the plurality of DUs.

10. A signal processing method of a basestation, comprising:
allocating transmission data to a predetermined frequency band and transmitting a transmission signal to which control information is allocated to a guard band in the predetermined frequency band, by a plurality of first processing units;
combining a plurality of transmission signals which is received from the plurality of first processing units into one signal to output the signal to the optical cable, by an optical transmitting unit;
splitting a reception signal which is received from the optical cable into a plurality of signals to transmit the signals to a plurality of second processing units, by the optical transmitting unit; and
extracting the control information from the guard band in the predetermined frequency band for a reception signal to perform a corresponding operation and extracting the transmission data from the predetermined frequency band to transmit the transmission data through the antenna, by the plurality of second processing units.

11. The method of claim 10, further comprising:
IF modulating the transmission signal by the plurality of first processing units; and
filtering a signal of the predetermined frequency band in the IF modulated signal.

12. The method of claim 10, further comprising:
filtering an IF band signal from the reception signal by the plurality of second processing units;
RF modulating the IF band signal; and
filtering a signal of the predetermined frequency band in the RF modulated signal.

13. The method of claim 10, further comprising:
before the transmitting of the transmission signal,
allocating different frequency bands to the plurality of first processing units.

14. The method of claim 10, further comprising:
before the transmitting of the transmission signal,
setting to detect a signal of the same frequency band as the corresponding first processing unit by the plurality of second processing units.
